(19) United States
(12) Patent Application Publication
(10) Pub. No.: US 2011/0060569 A1
(43) Pub. Date: Mar. 10, 2011

(54) Real-Time, Model-Based Autonomous Reasoner and Method of Using the Same

(75) Inventors: Christopher C. Lynn, Tucson, AZ (US); Byoung Uk Kim, Tucson, AZ (US); Neil Kunst, Tucson, AZ (US)

(73) Assignee: RIDGETOP GROUP, INC., Tucson, AZ (US)

(21) Appl. No.: 12/876,647

(22) Filed: Sep. 7, 2010

Related U.S. Application Data
(60) Provisional application No. 61/275,883, filed on Sep. 4, 2009.

(51) Int. Cl. G06G 7/48

(52) U.S. Cl. 703/6

(57) ABSTRACT

An apparatus and method for detecting and classifying in real-time characteristic of a system component is provided. A sensor senses the system component and outputs a first quantity of data corresponding to a characteristic of the system component. A modeler receives the first quantity of data, converts it to a numerical value and runs a computer model simulation to detect an anomalous behavior of the system component. The detected anomalous behavior is optimized and expressed as a second quantity of data. An autonomous reasoner collects the second quantity of data. A database has a plurality of signatures related to predominant modes of the system component. The autonomous reasoner compares the second quantity of data with the signatures and identifies a signature that matches the second quantity of data. An output indicative of a cause of the anomalous behavior of the system component is provided.

### CROSS REFERENCE TO RELATED APPLICATION

This application claims benefit of U.S. Provisional Application Ser. No. 61/275,883 filed Sep. 4, 2009, the entire disclosure of which is incorporated herein by reference.

### FIELD OF THE DISCLOSURE

The present disclosure is generally related to prognostic reasoners and more particularly is related to real-time, model-based autonomous reasoners and methods of using the same.

### BACKGROUND OF THE DISCLOSURE

Systems and system components are subject to degradation and failure after certain periods of time. As more industries evolve toward next generation electronic systems that replace traditional manually controlled systems, more components of systems are electronically controlled systems. Within the aviation industry, manually controlled aircraft are being replaced with fly-by-wire vehicles, and hydraulic and electro-hydrostatic actuators are replaced with their electro-mechanical counterparts. By eliminating fluid leakage problems in avionics, while reducing weight and enhancing vehicle control, feasibility and demand of electromechanical parts in avionic applications has been established. However, due to the inherent nature of the electronic components and system to fails, improved diagnostic and prognostic methods are sought to keep the all-electrical aircraft safe.

The same principle is applied throughout many industries. The need for greater efficiency and less mechanical problems within many industries and the systems in those industries is present. As more components of systems are replaced with electrical and electro-mechanical parts, the more prone the systems are to an electrical failure. When an electrical failure occurs, the system may not only endure down time, which is costly and hazardous, but some systems may cause resultant problems, such as significant safety hazards that could result in human injury or casualty.

Thus, a heretofore unaddressed need exists in the industry to address the aforementioned deficiencies and inadequacies.

### SUMMARY OF THE DISCLOSURE

Embodiments of the present disclosure provide a system and method for detecting and classifying in real-time a characteristic of a system component. Briefly described, in architecture, one embodiment of the system, among others, can be implemented as follows. The apparatus has at least one sensor positioned to sense the system component and output a first quantity of data corresponding to at least one characteristic of the system component. A computer modeler is in communication with the at least one sensor and receives the first quantity of data from the at least one sensor, wherein the computer modeler converts the first quantity of data into at least one numerical value and runs a computer model simulation. The computer model simulation models a present performance of the system component based on the at least one numerical value and compares the modeled present performance to an actual performance of the system component to detect an anomalous behavior of the system component. The detected anomalous behavior is optimized and expressed as a second quantity of data. An autonomous reasoner is in communication with the computer modeler wherein the autonomous reasoner collects the second quantity of data. A database is in communication with the autonomous reasoner and has a plurality of signatures related to predominant modes of the system component. The autonomous reasoner compares the second quantity of data with the signatures related to predominant modes of the system component in the database and identifies at least one signature related to predominant modes that substantially matches the second quantity of data. An output of the autonomous reasoner corresponds to the identified at least one signature, wherein the output is indicative of a cause of the at least one anomalous behavior of the system component.

The present disclosure can also be viewed as providing methods for detecting and classifying in real-time a characteristic of a system component. In this regard, one embodiment of such a method, among others, can be broadly summarized by the following steps: A method for detecting and classifying in real-time a characteristic of a system component, the method comprising the steps of: sensing the system component with at least one sensor; outputting from the at least one sensor a first quantity of data corresponding to at least one characteristic of the system component; receiving the first quantity of data at a computer modeler in communication with the at least one sensor; converting the first quantity of data into at least one numerical value; modeling a present performance of the system component based on the at least one numerical value; detecting an anomalous behavior of the system component by comparing the modeled present performance to an actual performance of the system component; optimizing the detected anomalous behavior and expressing it as a second quantity of data; collecting the second quantity of data with an autonomous reasoner in communication with the computer modeler; comparing the second quantity of data with a plurality of signatures related to predominant modes of the system component stored in a database in communication with the autonomous reasoner; identifying at least one signature related to predominant modes that substantially matches the second quantity of data; and outputting an output of the autonomous reasoner corresponding to the identified at least one signature, wherein the output is indicative of a cause of the at least one anomalous behavior of the system component.

The present disclosure can also be viewed as an apparatus for detecting and classifying in real-time a characteristic of a system component. Briefly described, in architecture, one embodiment of the system, among others, can be implemented as follows. The apparatus contains at least one sensor positioned to sense the system component and output a first quantity of data corresponding to at least one characteristic of the system component. A computer modeler is in communication with the at least one sensor and receives the first quantity of data from the at least one sensor, wherein the computer modeler runs a computer model simulation of the system component to detect an anomalous behavior of the system component, wherein the detected anomalous behavior is optimized and expressed as a second quantity of data. An autonomous reasoner is in communication with the computer modeler wherein the autonomous reasoner collects the second quantity of data. A database is in communication with the autonomous reasoner, the database having a plurality of signatures related to predominant modes of the system component, wherein the autonomous reasoner compares the second quantity of data with the signatures related to predominant modes of the system component in the database and identifies at least one signature related to predominant modes that substantially matches the second quantity of data. An output of the autonomous reasoner corresponds to the identified at least one signature, wherein the output is indicative of a cause of the at least one anomalous behavior of the system component.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of an apparatus for detecting and classifying in real-time a characteristic of a system component, in accordance with a first exemplary embodiment of the present disclosure.

FIG. 2 is a schematic illustration of an apparatus for detecting and classifying in real-time a characteristic of a system component, in accordance with the first exemplary embodiment of the present disclosure.

FIG. 3 is a schematic illustration of an apparatus for detecting and classifying in real-time a characteristic of a system component, in accordance with a second exemplary embodiment of the present disclosure.

FIG. 4 is a graph of a following error of an electro-mechanical actuator with just a single-aged MOSFET, in accordance with example 1.

FIG. 5 is a schematic diagram of a MATLAB/Simulink model of an electro-mechanical actuator, in accordance with example 1.

FIG. 6 is a flowchart illustrating a method for detecting and classifying in real-time a characteristic of a system component in accordance with the first exemplary embodiment of the disclosure.

### DETAILED DESCRIPTION

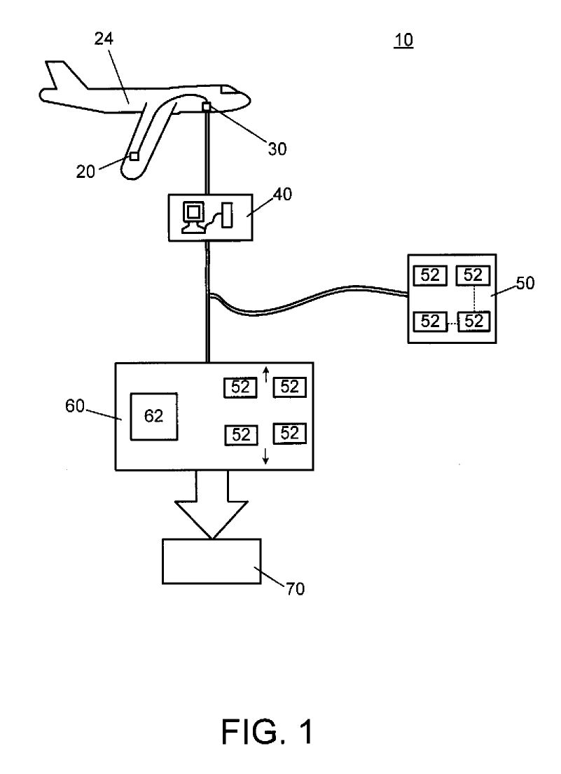

FIG. 1 is a schematic illustration of an apparatus 10 for detecting and classifying in real-time a characteristic of a system component 20, in accordance with a first exemplary embodiment of the present disclosure. The apparatus 10 includes at least one sensor 30 positioned to sense a system component 20 and output a first quantity of data corresponding to at least one characteristic of the system component 20. The system component 20 may be any type of device having a measurable property and is located within a system 24. A computer modeler 40 is in communication with the sensor 30 and receives the first quantity of data from the sensor 30. The computer modeler 40 converts the first quantity of data into at least one numerical value and runs a computer model simulation. The computer model simulation models a present performance of the system component 20 based on the numerical value and compares the modeled present performance to an actual performance of the system component 20 to detect an anomalous behavior of the system component 20. The detected anomalous behavior is optimized and then expressed as a second quantity of data.

An autonomous reasoner 60 is in communication with the computer modeler 40 and collects the second quantity of data. A database 50 is in communication with the autonomous reasoner 60 and has a plurality of signatures 52 related to predominant modes of the system component 20. The autonomous reasoner 60 compares the second quantity of data 62 with the signatures 52 related to predominant modes of the system component 20 in the database 50 and identifies at least one signature 52 related to predominant modes that substantially matches the second quantity of data 62. An output 70 of the autonomous reasoner 60 corresponds to the identified at least one signature 52, wherein the output 70 is indicative of a cause of the at least one anomalous behavior of the system component 20.

The apparatus 10 may be used with a variety of different types of system components 20 on a variety of systems 24. The systems 24 may include any type of system, machine, device or series of devices that uses computerized, mechanical, electrical and/or electro-mechanical components. This may include systems 24 such as aircrafts, watercrafts, trains, vehicles, robotic machines, programmable machines, industrial tools or any other type of system 24 subject to component degradation. As is illustrated in FIG. 1, the apparatus 10 is primarily discussed with regards to the avionics industry, as aircraft have many components subject to degradation and/or failure over time. As one having skill in the art can see, the apparatus 10 may be used in any industry that utilizes systems 24 capable of degradation, wear and/or failure, all of which are considered within the scope of this disclosure.

The system component 20 may include a number of different types of devices used on, within, or in connection to the system 24. The system component 20 may include components that are computerized, mechanical, electrical and/or electro-mechanical components, or any combination thereof. The system component 20 may be any other device that has a measurable property, that has one or more equations that can be written to govern or describe its operation and is subject to degradation, wear and/or failure, in one or more ways. For example, as illustrated in FIG. 1, the system component 20 may be an actuator or a target flight control system used with an aircraft, wherein the response time or movement of the actuator is measurable. In another example, the system component 20 may be an electrical part on a machine, such as a transistor, a capacitor, and/or any other element that is part of a power drive stage of an electro-mechanical device, wherein the physical degradation of the device can be measured and/or modeled.

At least one sensor 30 is positioned to sense the system component 20 and compile a first quantity of data from the system component 20. The sensor 30 may sense the system component 20 by monitoring communications of the system 24 of a bus or similar data transmission system, and retrieve data from one or more signals transmitted over the bus. For example, the sensor 30 could be a bus monitor located on the system 24. The sensor 30 may also create or output a sensor output that is stored or collected from the sensor 30. This stored sensor output may include historical operation data, such as historical flight data or any other type of data that is stored as post real-time data. The stored sensor output may be the same or different from the first quantity of data, and may depend on the type of system 24 that the apparatus 10 is used with. The computer modeler 40 may optimize the detected anomalous behavior at least partly based on the stored sensor output, thereby taking into considerations historical operational information of the system 24 when optimizing the detected anomalous behavior.

The first quantity of data may correspond to at least one characteristic of the system component 20. The at least one characteristic of the system component 20 may include any number or type of characteristic associated with the system component 20, such as a characteristic related to a degradation state of the system component 20, a characteristic related to an environmental condition or physical condition of the system 24 or system component 20, and/or a characteristic related to another working state of the system component 20. Other characteristics may include position, trajectory and/or any other detectable condition, or combination thereof. The first quantity of data corresponding to the at least one characteristic of the system component 20 is output from the sensor 30. The first quantity of data may be expressed in a number of ways, including in one coordinate, in two coordinates or in more than two coordinates, and the quantity of data may be visually graphed on one or more axes.

The computer modeler 40 receives the first quantity of data from the sensor 30 and converts the first quantity of data into at least one numerical value. This may include converting the first quantity of data into any quantity of numbers having any format, including numbers expressed with variables and/or by equation. The computer modeler 40 may run a computer model simulation to model a present performance of the system component 24. This may be based on, at least in part, the numerical value that the first quantity of data is converted into, and/or any equation derived therefrom. The computer modeler 40 may compare the modeled present performance to an actual performance of the system component 20. The modeled present performance may describe how the system component 20 should function and the actual performance of the system component 20 may describe how the system component 20 is actually function. The computer modeler 40 may detect an anomalous behavior of the system component 20 based on the comparison. An anomalous behavior may commonly be detected when the modeled present performance and the actual performance of the system component 20 do not substantially match.

Any anomalous behavior that is detected may be optimized. The computer modeler may adjust, or optimize any anomalous behavior to accurately represent the values and the systems parameters at that point in time for that performance. Optimizing the anomalous behavior may also be understood and disclosed as optimizing the first quantity of data, since the optimization may occur at any time within the computer modeler 40 prior to the second quantity of data being sent to the autonomous reasoner 60. Optimizing the anomalous behavior may include adjusting a quantity of pre-specified variables until a substantially suitable match between the optimizing model and the present performance is reached. Once completed, a second quantity of data may be found, or an iteration limit may be reached. When an iteration limit is reached, there may be no substantially suitable match available. Optimizing the anomalous behavior may be done electronically within the computer modeler 40, or manually with one or more knobs or adjustment controls, or any combination thereof.

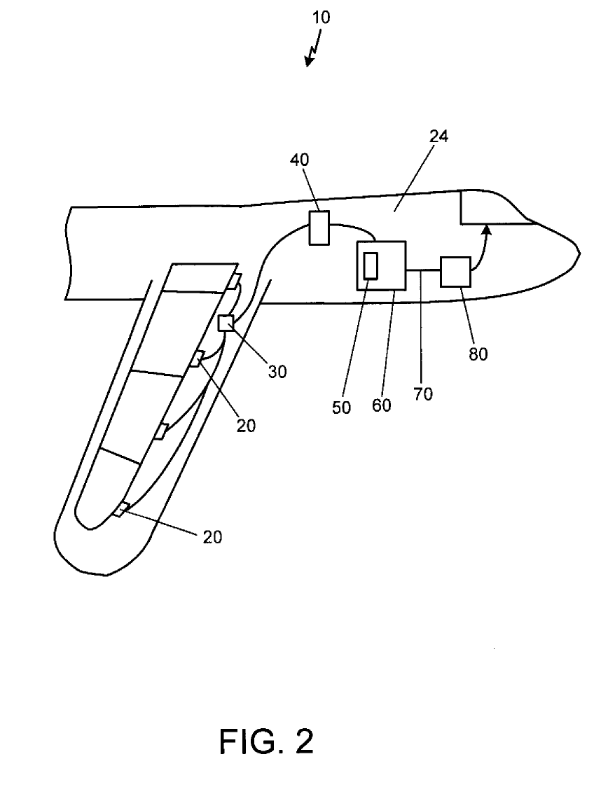

The autonomous reasoner 60 may be in communication with at least the database 50 and the computer modeler 40. This communication, as well as any other communication between components in the apparatus 10 may be facilitated by any communication connection, such as a wired communication connection or a wireless communication connection, as is discussed further with regards to FIG. 2. The autonomous reasoner 60 may receive or collect the second quantity of data from the computer modeler 40. Then the second quantity of data may be compared with a list of criteria in the autonomous reasoner and if the second quantity of data fit one or more of the criteria then the resulting failure mode that corresponds to those criteria is outputted from the reasoner to a system that can present, or not present, the results.

The database 50 may be in communication with the autonomous reasoner 60, the computer modeler 40, or any other component by any type communication connection. For example, the database 50 may be integral with the autonomous reasoner 60, such as a hard drive that is directly connected to the autonomous reasoner 60. Additionally, the database 50 may be located remote from the autonomous reasoner 60 and accessible from a communication connection such as a network, an Internet connection, a dedicated wireless band or any other type of connection. In FIG. 1, only one database 50 is illustrated, but any number of databases 50 may be included. Furthermore, the database(s) 50 may be keyed to specific systems 24, specific system components 20, or specific characteristics of the system component 20. For example, there may be one or more databases 50 for each system component 20 within the system 24 or one or more databases 50 for each system 24. The database 50 may also be keyed to a particular characteristic or operation of a plurality of system components 20, as many system components 20 may use similar parts that are subject to degradation in similar ways.

The database 50 has a plurality of signatures 52 related to predominant modes of the system component 20. The signatures 52 may be considered a string of data and may be expressed in any number of coordinates and/or dimensions. To those having skill in the art, the database 50 may be considered a dictionary or a library of signatures 52. Each of the signatures 52 is related to predominant modes of the system component 20. In other words, each of the signatures 52 represents a state of the system component 20, such as a degradation state, a failing state, a successfully working state, or any combination thereof. As one skilled in the art can see, a vast number of signatures 52 may be included in the database 50 to account for the vast number of possibilities of the state of the system component 20.

The autonomous reasoner 60 may compare the second quantity of data with one or more of the signatures 52 related to predominant modes of the system component 20 in the database 50. The autonomous reasoner may identify at least one signature 52 that is related to one or more predominant modes that substantially matches the second quantity of data. A signature 52 that substantially matches the second quantity of data may include a signature 52 that is closely identical to at least a portion of the second quantity of data, but may also include a signature 52 that is approximately similar to, in at least one way, the second quantity of data. The autonomous reasoner 60 may then produce an output 70 of the identified signature 52.

Practically speaking, the second quantity of data may be compiled as a series or list of numbers that the autonomous reasoner 60 compares to signatures 52 in a numerical format. However, one skilled in the art will understand that the characteristic of the system component 20 that the second quantity of data corresponds to may be visually identifiable graphically. For example, the second quantity of data may include a measurement of movement of a system component 20, such as an airplane wing-flap actuator, over a given period of time. The database 50 may include a plurality of signatures 52 that represent when the airplane wing-flap actuator is performing correctly, or when the airplane wing-flap actuator has experienced some level of degradation. As the movement of the airplane wing-flap actuator is recorded over the given period of time, the second quantity of data may include the characteristic identified by a portion of the second quantity of data, or a series of patterns within the second quantity of data. When the second quantity of data is compared to the signatures 52, the autonomous reasoner 60 may identify one or more signatures 52 that include a characteristic that substantially matches the characteristic identified in the second quantity of data. The signature 52 may further correspond to an identifiable type of degradation of the system component 20.

Once the at least one signature 52 is identified by the autonomous reasoner 60, the autonomous reasoner 60 produces an output 70 corresponding to the identified at least one signature 52. The output 70 may commonly be an electronic message that is communicated to a system computer, an operator of the system 24, any component within the system 24, a database and/or a third party, such as a remote control station. However, the output 70 may be given in any format and may be directed to any computer, person or entity. The output 70 includes information that is indicative of a cause of the at least one characteristic of the system component 20. In other words, the output 70 may identify which at least one signature 52 substantially matches the characteristic identified in the second quantity of data, and then provide further information on what is causing the characteristic within the system component 20.

The output 70 may be indicative of the cause of the at least one characteristic of the system component 20 in a variety of ways, depending on the design of the apparatus 10 and its intended use. For example, the output 70 may provide specific information on what is causing the characteristic, such as detailing which part of the system component 20 is malfunctioning or operating outside of normal operation parameters. If the system component 20 is an electrically driven motor, the output 70 may provide information that a certain coil within the electrically driven motor is causing the characteristic. The output 70 may also provide a general indication of the cause of the characteristic within the system component 20, such as by indicating the operation of the system component 20 (i.e., failed or working), or by providing a percentage determination of the operating status of the system component 20 (i.e., 50% working or 75% failed). As the characteristic may include a variety of causes, the output 70 may provide more than one indication of the cause.

The apparatus 10 may be designed to provide a passive response to the characteristic of a system component 20, an active response to the characteristic of the system component 20 or a combination thereof. The apparatus 10 may be provided as a separate unit to an existing system 24, or may be embedded within the system 24 or a fully integrated system-on-chip commercial solution. The apparatus 10 allows for an early warning of incipient fault conditions of the system component 20, which may allow for the system component 20 to be fixed in a timely manner. This, in turn, will lead to better maintenance of the system 24, which provides for a safer use of the system 24 and a more reliable system 24.

Furthermore, the apparatus 10 is fully modifiable to allow it to be used with a wide range of systems 24. For example, the apparatus 10 may be modified with a set of physics equations that are written in terms of the symbolic variables that describe the system and estimates for the variables values must be known. The prototype provide a graphical user interface (GUI) that asks for the equations in symbolic state-space form and then provides a place for every variable to be estimated and have upper and lower limits set; these limits constrain the solver to realistic values. Another important aspect that the apparatus 10 includes is the ability to effectively decouple the autonomous reasoner 60 from the system component 20, which thereby allows the autonomous reasoner 60 the ability to support multiple systems 24 or multiple system computers 80 (see FIG. 2). Using one autonomous reasoner 60 for multiple systems 24 may simplify adoption, validation, integration, and support of the apparatus 10. Potentially, a single autonomous reasoner 60 may monitor multiple systems 24 and multiple system components 20, which may optimize overall sensor costs. The autonomous reasoner 60 may be implemented with a number of software systems and/or field upgradeable firmware that would be capable of supporting evolving interface standards and prognostic health measurement capabilities.

FIG. 2 is a schematic illustration of an apparatus for detecting and classifying in real-time a characteristic of a system component 10, in accordance with the first exemplary embodiment of the present disclosure. The apparatus 10 may include a number of other features to enhance convenience, usefulness and operation of the apparatus 10. For example, the system 24 may include a system computer 80, which is programmed to at least partially control the system component 20, among other components on the system 24. The system computer 80 may be a flight control computer onboard an aircraft, as is shown in FIG. 2, or any other type of system computer 80 on any other system 24.

The output 70 of the autonomous reasoner 60 may be communicated to the system computer 80, which may then process the output 70 in a number of ways. The system computer 80 may adjust a control of the system component 20 based on the indicated cause of the at least one characteristic of the system component 20. For example, if the system component 20 is a wing-flap actuator that is not responding fully to commands, the output 70 may indicate that the cause of the problem is a faulty actuator motor. The system computer 80 may adjust future commands given to the wing-flap actuator to account for the faulty actuator motor to allow for operation of the system 24 until the faulty actuator motor can be fixed or replaced. Accordingly, the system computer 80 adjusting control of the system component 20 may allow an operator of the system 24 to continue to operate the system 24 as if the system component 20 was working correctly.

In addition to making an adjustment of control over the system component 20, the system computer 80 may also notify an operator, a computer, or another entity of the cause indicated by the output 70. This may make the operator or other entity aware of the cause, even if the system computer 80 does not need to adjust control of the system component 20. This may include a notification of a system 24 error, a notification of a system component 20 error, a notification of adjustment of control of the system component 20, a notification of the output 70 of the autonomous reasoner 60 and/or a recommendation for future operation of the system 24, or any combination thereof. As one having skill in the art can see, an operator of the system 24 having knowledge of a system component's 20 failure, state of degradation or other working status state, may allow the operator, such as a pilot or air traffic controller, to operate the system 24 more safely. The operator may account for the system component 20 failure or present working state, and make manual adjustments, if need be. The system computer 80 may also log or store any outputs 70 received from the autonomous reasoner 60 within a local or remote database.

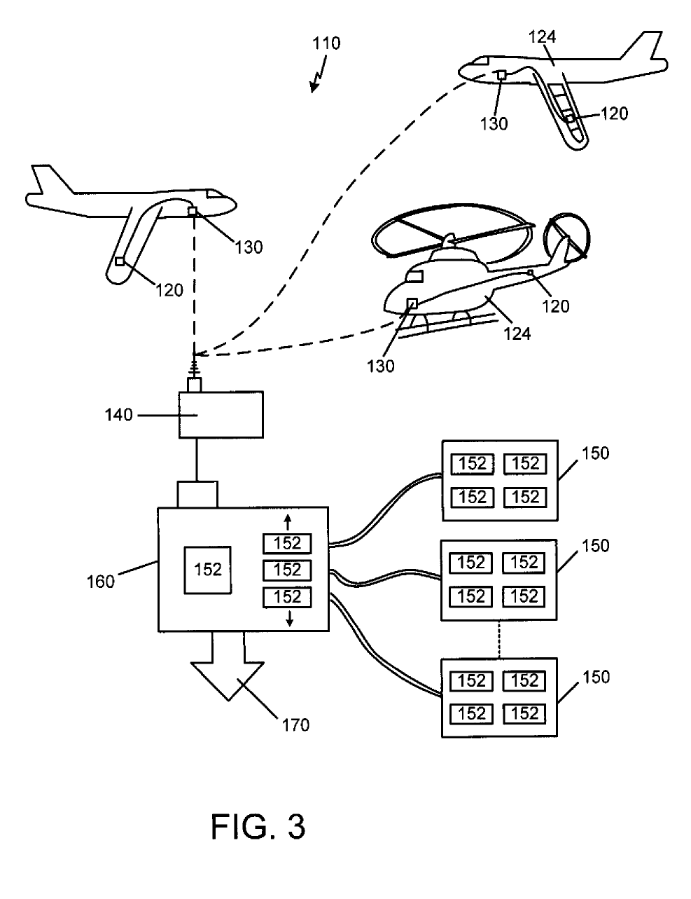

FIG. 3 is a schematic illustration of an apparatus 110 for detecting and classifying in real-time a characteristic of a system component 120, in accordance with a second exemplary embodiment of the present disclosure. The apparatus 110 for detecting and classifying in real-time a characteristic of a system component 120, is substantially similar to the apparatus 10 of the first exemplary embodiment. The apparatus 110 includes one autonomous reasoner 160 that may be in communication with multiple sensors 130. In FIG. 3, the multiple sensors 130 are illustrated being located in multiple systems 124, although the multiple sensors 130 may also be located within one system 124. The communication connection between the autonomous reasoner 160 and the systems 124 may be a wireless communication connection, whereby multiple first quantities of data are first transmitted through one or more wireless communication systems to one or more computerized modelers 140. Additionally, the autonomous reasoner 160 may be in communication with one or more databases 150, and the autonomous reasoner 160 may produce an output 170 that may be communicated via a wired or wireless connection.

Although the principle operation of the apparatus 110 is similar to the operation of the apparatus 10 of the first exemplary embodiment, the apparatus 110 may include a different architecture for operation. For example, the apparatus 110 may include a variety of system components 120 that are sensed by one or more sensors 130, which output many first quantities of data to the computer modeler 140, which may output many second quantities of data to the autonomous reasoner 160. Practically, the autonomous reasoner 160 may be located in a stationary position, but may be located proximate to or remote from the system 124, depending on what type of system 124 is present. If the system 124 is an aircraft, then the autonomous reasoner 160 may be located within an airport or central operation center that is hundreds or thousands of miles from the aircraft. If the system 124 is an industrial machine in a factory, then the autonomous reasoner 160 may also be conveniently located within the factory. In addition, the autonomous reasoner 160 may be located with a manufacturer of the system 124, or in a location proximate to and/or accessible to a maintenance provider.

### Example 1

Example 1 provides an illustration of the apparatus for detecting and classifying in real-time the characteristic of a system component in accordance with the first and second exemplary embodiments. The example uses an aircraft as the system and an electro-mechanical actuator as the system component.

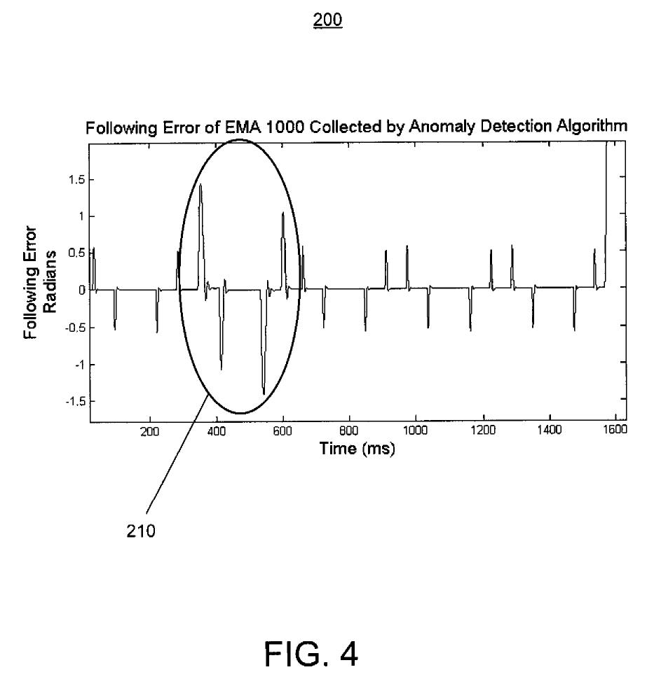

FIG. 4 is a graph 200 of a following error 210 of an electro-mechanical actuator with just a single-aged MOSFET, in accordance with Example 1. The following error 210 in an electro-mechanical actuator reveals a great deal about its health. Following error 210 may be an indication of the variance between a commanded position and an actual position of the associated control surface. The following error 210 may be directly correlated with physical degradation of the metal-oxide-semiconductor field-effect transistor (MOSFET), capacitors, and other elements that comprise the power drive stage of the electro-mechanical actuator. The following error 210 may indicate how an anomalous electromechanical actuator operation just prior to catastrophic failure provided helpful insight into the failure mechanism. Many symptoms of an electro-mechanical actuator, electronic power system, and MOSFET can be observed from the following error and modeled in a modeling program, like a MATLAB/Simulink program.

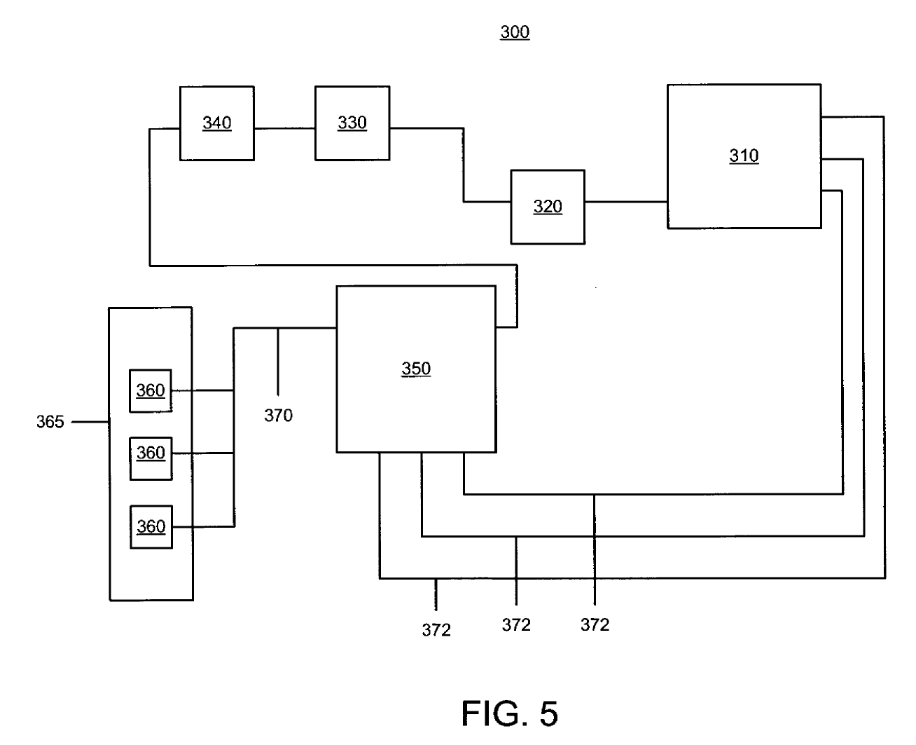

FIG. 5 is a schematic diagram of a MATLAB/Simulink model 300 of an electro-mechanical actuator, in accordance with Example 1. With reference to FIG. 5, a brushless direct-current (BLDC) motor model 310 is connected to an H-bridge power stage 320 including the MOSFET switches. A back electromotive force (EMF) sensing block 330 is connected to the H-bridge power stage 320. A pulse width modulation signal generator 340 is connected to the EMF sensing block 330, and a variable DC-link voltage control block 350, which comprises a position control, a speed control, and a present control in a row. The variable DC-link voltage control block 350 receives a created reference signal from a plurality of signal builders 360, located within a hardware interface 365. The signal builders may be at least one of a “Position Signal”, “Speed Signal”, or “Current Signal”. A reference signal 370 may be fed to the variable DC-link voltage control block 350, which compares the reference signal 370 with every actual signal 372 coming from the BLDC motor model 310. For example, the BLDC motor model 310 and the system may have the same inputs but may return different results to the same command, which can be detected through comparison. Accordingly, the comparison of the reference signal 370 and the actual signal 372 may be used to determine if there is the characteristic within the electromechanical actuator.

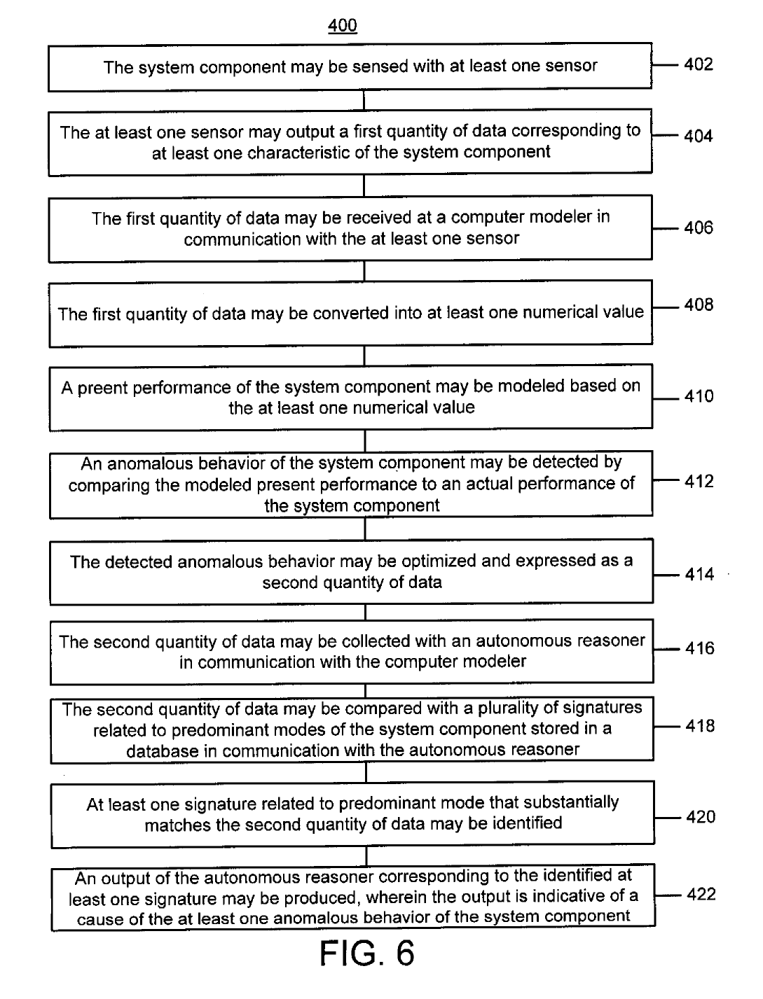

FIG. 6 is a flowchart 400 illustrating a method for detecting and classifying in real-time a characteristic of a system component 20 in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 402, the system component 20 may be sensed with at least one sensor 30. The at least one sensor 30 may output a first quantity of data corresponding to at least one characteristic of the system component 20 (Block 404). The first quantity of data may be received at a computer modeler 40 in communication with the at least one sensor 30 (Block 406). The first quantity of data may be converted into at least one numerical value (Block 408). A present performance of the system component 20 may be modeled based on the at least one numerical value (Block 410). An anomalous behavior of the system component 20 may be detected by comparing the modeled present performance to an actual performance of the system component (Block 412). The detected anomalous behavior may be optimized and expressed as a second quantity of data (Block 414). The second quantity of data may be collected with an autonomous reasoner 60 in communication with the computer modeler 40 (Block 416). The second quantity of data may be compared with a plurality of signatures 52 related to predominant modes of the system component stored in a database 50 in communication with the autonomous reasoner 60 (Block 418). At least one signature 52 related to predominant mode that substantially matches the second quantity of data may be identified (Block 420). An output 70 of the autonomous reasoner 60 corresponding to the identified at least one signature 52 may be produced, wherein the output 70 is indicative of a cause of the at least one anomalous behavior of the system component 20 (Block 422).

A number of other steps may be included with the method, as disclosed herein. For example, the autonomous reasoner 60 may be connected, either with a wired connection or a wireless connection, with at least one of the at least one sensor 30 and the database 50. Additionally, the method may include the steps of at least partially controlling the system component 20 with a system computer; communicating the output 70 of the autonomous reasoner 60 to the system computer; and adjusting a control of the system component 20 based on the indicated cause of the at least one characteristic of the system component 20. A communication may be sent from the system computer to an operator of a system 24 in which the system component 20 is located, wherein the communication includes at least one of a notification of a system 24 error, a notification of a system component 20 error, a notification of adjustment of control of the system component 20, a notification of the output 70 of the autonomous reasoner 60 and a recommendation for future operation of the system 24.

Additionally, a plurality of system components 20 may be provided. The plurality of system components 20 may be sensed with the at least one sensor 30, and a second quantity of data corresponding to at least one characteristic for each of the plurality of system components 20 may be output 70 from the at least one sensor 30. The plurality of system components 20 may be housed within a single system 24, or in a plurality of independent systems 24. When the second quantity of data is output, it may be substantially matched with at least one of the plurality of signatures 52 related to predominant modes of the system component 20, which may correspond to at least one state of degradation of the system component 20. The second quantity of data and/or the signature 52 may be graphically modeled in at least two coordinates.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. An apparatus for detecting and classifying in real-time a characteristic of a system component, the apparatus comprising:
at least one sensor positioned to sense the system component and output a first quantity of data corresponding to at least one characteristic of the system component;
a computer modeler in communication with at least one sensor and receiving the first quantity of data from the at least one sensor, wherein the computer modeler converts the first quantity of data into at least one numerical value and runs a computer model simulation, wherein the computer model simulation models a present performance of the system component based on the at least one numerical value and compares the modeled present performance to an actual performance of the system component to detect an anomalous behavior of the system component, wherein the detected anomalous behavior is optimized and then expressed as a second quantity of data;
an autonomous reasoner in communication with the computer modeler wherein the autonomous reasoner collects the second quantity of data;
a database in communication with the autonomous reasoner, the database having a plurality of signatures related to predominant modes of the system component, wherein the autonomous reasoner compares the second quantity of data with the signatures related to predominant modes of the system component in the database and identifies at least one signature related to predominant modes that substantially matches the second quantity of data; and
an output of the autonomous reasoner corresponding to the identified at least one signature, wherein the output is indicative of a cause of the at least one anomalous behavior of the system component.

2. The apparatus for detecting and classifying in real-time a behavior of the system component of claim 1, wherein the at least one sensor senses the system component by retrieving at least one signal within a bus.

3. The apparatus for detecting and classifying in real-time a behavior of the system component of claim 1, wherein the computer modeler optimizes the detected anomalous behavior by adjusting a quantity of pre-specified variables until at least one of a substantially suitable match for the second quantity of data is found and an iteration limit is reached.

4. The apparatus for detecting and classifying in real-time a behavior of the system component of claim 3, wherein the iteration limit is reached when no substantially suitable match is found.

5. The apparatus for detecting and classifying in real-time a behavior of the system component of claim 1, wherein the anomalous behavior of the system component is detected when the modeled present performance and the actual performance of the system component are not substantially matched.

6. The apparatus for detecting and classifying in real-time a behavior of the system component of claim 1, wherein communication between at least one of the computer modeler and the at least one sensor, the autonomous reasoner and the computer modeler, and the database and the autonomous reasoner is facilitated with at least one wired communication connection.

7. The apparatus for detecting and classifying in real-time behavior of the system component of claim 1, wherein communication between at least one of the computer modeler and the at least one sensor, the autonomous reasoner and the computer modeler, and the database and the autonomous reasoner is facilitated with at least one wireless communication connection.

8. The apparatus for detecting and classifying in real-time behavior of the system component of claim 1, further comprising a system computer programmed to at least partially control the system component, wherein the output of the autonomous reasoner is communicated to the system computer, whereby the system computer adjusts control of the system component based on the indicated cause of the at least one anomalous behavior of the system component.

9. The apparatus for detecting and classifying in real-time behavior of the system component of claim 8, wherein the system computer sends a communication to an operator of a system, wherein the communication includes at least one of a notification of a system error, a notification of a system component error, a notification of adjustment of control of the system component, a notification of the output of the autonomous reasoner and a recommendation for future operation of the system.

10. The apparatus for detecting and classifying in real-time behavior of the system component of claim 1, wherein the system component further comprises a plurality of system components positioned to be sensed by the at least one sensor and the first quantity of data corresponds to at least one characteristic for each of the plurality of system components.

11. The apparatus for detecting and classifying in real-time behavior of the system component of claim 10, wherein the plurality of system components are housed within at least two independent systems.

12. The apparatus for detecting and classifying in real-time behavior of a system component of claim 1, wherein each of the plurality of signatures related to predominant modes of the system component substantially match at least one state of degradation of the system component.

13. The apparatus for detecting and classifying in real-time behavior of the system component of claim 12, wherein the at least one state of degradation corresponds to an identifiable type of degradation of the system component.

14. The apparatus for detecting and classifying in real-time behavior of the system component of claim 1, wherein the modeled a present performance of the system component is based in part, on at least one of an environmental condition and a physical condition.

15. The apparatus for detecting and classifying in real-time behavior of the system component of claim 1, wherein the computer modeler optimizes the detected anomalous behavior in substantially real-time.

16. The apparatus for detecting and classifying in real-time behavior of the system component of claim 1, further comprising a sensor output from the at least one sensor, wherein the sensor output is stored, and wherein the computer modeler optimizes the detected anomalous behavior at least partly based on the stored sensor output.

17. A method for detecting and classifying in real-time a characteristic of a system component, the method comprising the steps of:
sensing the system component with at least one sensor;
outputting from the at least one sensor a first quantity of data corresponding to at least one characteristic of the system component;
receiving the first quantity of data at a computer modeler in communication with the at least one sensor;
converting the first quantity of data into at least one numerical value;
modeling a present performance of the system component based on the at least one numerical value;
detecting an anomalous behavior of the system component by comparing the modeled present performance to an actual performance of the system component;
optimizing the detected anomalous behavior and expressing it as a second quantity of data;
collecting the second quantity of data with an autonomous reasoner in communication with the computer modeler;
comparing the second quantity of data with a plurality of signatures related to predominant modes of the system component stored in a database in communication with the autonomous reasoner;
identifying at least one signature related to predominant modes that substantially matches the second quantity of data; and
outputting an output of the autonomous reasoner corresponding to the identified at least one signature, wherein the output is indicative of a cause of the at least one anomalous behavior of the system component.

18. The method for detecting and classifying in real-time characteristic of the system component 17, wherein the step of sensing the system component with at least one sensor further comprises retrieving at least one signal within a bus.

19. The method for detecting and classifying in real-time characteristic of the system component 17, wherein the step of optimizing the detected anomalous behavior with the computer modeler further comprises adjusting a quantity of pre-specified variables until at least one of a substantially suitable match for the second quantity of data is found and an iteration limit is reached.

20. The method for detecting and classifying in real-time characteristic of the system component 17, wherein the iteration limit is reached when no substantially suitable match is found.

21. The method for detecting and classifying in real-time characteristic of the system component 17, wherein the step of detecting the anomalous behavior of the system component further comprises detecting the anomalous when the modeled present performance and the actual performance of the system component are not substantially matched.

22. The method for detecting and classifying in real-time characteristic of the system component 17, further comprising the step of activating an autonomous reasoner when an anomalous behavior of the system component is detected.

23. The method for detecting and classifying in real-time characteristic of the system component 17, further comprising the steps of:
at least partially controlling the system component with a system computer;
communicating the output of the autonomous reasoner to the system computer; and
adjusting a control of the system component based the indicated cause of the at least one anomalous behavior of the system component.

24. The method for detecting and classifying in real-time characteristic of the system component 23, further comprising the step of sending a communication from the system computer to an operator of a system, wherein the communication includes at least one of a notification of a system error, a notification of a system component error, a notification of adjustment of control of the system component, a notification of the output of the autonomous reasoner and a recommendation for future operation of the system.

25. The method for detecting and classifying in real-time characteristic of the system component 17, further comprising the steps of:
sensing a plurality of system components with the at least one sensor; and
outputting the quantity of data corresponding to the at least one characteristic for each of the plurality of system components.

26. The method for detecting and classifying in real-time characteristic of the system component 25, further comprising the step of housing the plurality of system components within at least two independent systems.

27. The method for detecting and classifying in real-time characteristic of the system component 17, further comprising the step of substantially matching each of the plurality of signatures related to predominant modes of the system component to at least one state of degradation of the system component.

28. The method for detecting and classifying in real-time characteristic of the system component 27, wherein the at least one state of degradation corresponds to an identifiable type of degradation of the system component.

29. An apparatus for detecting and classifying in real-time a characteristic of a system component:
at least one sensor positioned to sense the system component and output a first quantity of data corresponding to at least one characteristic of the system component;
a computer modeler in communication with the at least one sensor and receiving the first quantity of data from the at least one sensor, wherein the computer modeler runs a computer model simulation of the system component to detect an anomalous behavior of the system component, wherein the detected anomalous behavior is optimized and expressed as a second quantity of data;
an autonomous reasoner in communication with the computer modeler wherein the autonomous reasoner collects the second quantity of data;
a database in communication with the autonomous reasoner, the database having a plurality of signatures related to predominant modes of the system component, wherein the autonomous reasoner compares the second quantity of data with the signatures related to predominant modes of the system component in the database and identifies at least one signature related to predominant modes that substantially matches the second quantity of data; and
an output of the autonomous reasoner corresponding to the identified at least one signature, wherein the output is indicative of a cause of the at least one anomalous behavior of the system component.
